(19) United States
(12) Patent Application Publication
(10) Pub. No.: US 2006/0125356 A1
(43) Pub. Date: Jun. 15, 2006

(54) Mobile point of care system and associated method and computer program product

(75) Inventors: Robert B. Meek JR., Pittsburgh, PA (US); Philip Spano, McKees Rocks, PA (US); Mary Beth Navarra, Pittsburgh, PA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: McKesson Automation Inc.

(21) Appl. No.: 11/292,451

(22) Filed: Dec. 2, 2005

Related U.S. Application Data
(60) Provisional application No. 60/633,075, filed on Dec. 3, 2004.

(51) Int. Cl. E05B 65/46

(52) U.S. Cl. 312/215

(57) ABSTRACT

A wireless, mobile point-of-care system is provided including a plurality of mobile point-of-care carts, each capable of transporting a plurality of patient-specific medication or supply drawers or containers. The mobile point-of-care carts provide for both auto-identification of patient containers carried by the cart, as well as real-time tracking of the carts themselves. Using the combination of these two features, each patient-specific drawer can be located throughout the hospital at any given time. A method is further provided for utilizing this location information to generate a medication delivery/removal plan or route, which can be used by delivery personnel to alleviate the burden caused by making medication carts mobile.

### CROSS-REFERENCE TO RELATED APPLICATIONS

The present application claims priority from U.S. Provisional Application No. 60/633,075, filed Dec. 3, 2004 entitled Mobile Point of Care System, the contents of which are incorporated herein in their entirety.

### FIELD OF THE INVENTION

Exemplary embodiments of the present invention are directed generally to mobile carts used for dispensing medications in a healthcare setting. Exemplary embodiments are further directed to a method of delivering medications to the mobile carts.

### BACKGROUND OF THE INVENTION

According to a conventional pharmacy dispensing scenario, each day a pharmacist will dispense all of the medications known to be needed for all of the patients throughout a hospital, nursing home or other similar facility, for that particular day. These medications are typically divided up and delivered to various medication rooms located, for example, on each floor of the hospital, or in each unit or wing. A nurse will then visit the medication room to get the medications needed for a particular patient. He or she will then, if necessary, go to a supply room to get the supplies needed to administer the medications (e.g., syringes, gauze, etc.). The nurse will later need to visit a computer, for example at a nurses station or in the hallway, to enter information regarding the medications administered. The nurse will have to repeat this process for every patient he or she treats within a given day. As is evident from the foregoing, this process can be very time consuming.

In most institutions, medications are maintained in stationary carts located in specific areas of the patient care unit, such as in a medication room. Pharmacy or nursing department staff must visit these carts to retrieve scheduled medications and new medication therapies, as well as to remove discontinued medications. To alleviate some of the burden of having to constantly revisit the medication carts, mobile medication carts were introduced.

Mobile medication dispensing carts are known in the art. For example, U.S. Pat. No. 5,314,243 discloses a portable nursing center having a plurality of selectively locked patient drawers carried in a housing. Each of the drawers is movable between an open position and a closed position. Each drawer is sized and configured for holding pharmaceutical items that have been prescribed for a specific patient. At least one on demand drawer is also carried by the housing, movable between an open position and a closed position and being sized and configured to hold pharmaceutical and other nursing items used on an as needed basis. A nurse enters predetermined access data and other data, causing the unit to selectively unlock the appropriate patient drawer or on demand drawer while maintaining other drawers in a locked condition. Whenever the patient is given medicine or otherwise treated, the nurse enters or receives information pertinent to that treatment. The unit has a transmitter/receiver to transmit and receive such patient information.

With the introduction of a mobile medication management system, the traditional process of delivering medications to a stationary location breaks down. Instead of being able to deliver medications to a dozen or so medication rooms, or even to stationary medication carts, the burden has now shifted somewhat to the medication delivery personnel who now must deliver medications to hundreds of patient-specific containers or drawers contained in mobile medication carts scattered throughout the hospital. Pharmacy and nursing staff desirably have a means for locating patient medication containers if these containers are no longer being maintained in specific areas on the patient care unit.

In addition, current medication cart systems which combine a computing platform with a medication cart require nurses to log-in to the computer application to perform certain functions, and they also require that a nurse enter a code to access locked patient containers. That is a cumbersome process for caregivers and it leads to unnecessary time spent.

Further, one of the current complaints of nursing and pharmacy staff alike is their inability to effectively communicate with each other while performing patient care activities. For example, if a question about patient medication arises, nurses often interrupt care in order to telephone the Pharmacy department. No product on the market is known to have effectively solved this problem.

Thus, a need exists for a mobile cart that provides auto-identification of medication containers, real-time cart locating, application control of the medication cart drawer locking mechanism, cart-to-cart and cart-to-pharmacy communications systems.

### BRIEF SUMMARY OF THE INVENTION

Generally described, exemplary embodiments of the present invention provide an improvement over the known prior art by, among other things, providing a wireless, mobile point-of-care system. In exemplary embodiments, the mobile point-of-care system includes a plurality of mobile point-of-care carts, each capable of transporting a plurality of patient-specific medication or supply drawers or containers. The mobile point-of-care carts of exemplary embodiments provide for both auto-identification of patient containers carried by the cart, as well as real-time tracking of the carts themselves. Using the combination of these two features, each patient-specific drawer can be located throughout the hospital at any given time. Exemplary embodiments of the present invention further utilize this location information to provide a method of generating a medication delivery/removal plan or route, which can be used by delivery personnel to alleviate the burden caused by making medication carts mobile.

According to one aspect of the present invention a wireless, mobile point-of-care cart is provided. In one exemplary embodiment, the cart includes: (1) a mobile frame including a housing that defines a plurality of drawer receptacles and carries at least one reader; and (2) a plurality of drawers each sized to fit within one of the drawer receptacles. Each drawer of exemplary embodiments carries a memory device capable of retaining patient-specific data, wherein the patient-specific data is capable of being read from the memory device by the at least one reader.

In one exemplary embodiment, each drawer receptacle carries a corresponding reader. In another exemplary embodiment, the memory device comprises a radio-frequency identification (RFID) tag, and the reader is an RFID reader. A programming device may further be carried by the housing of the cart, according to another exemplary embodiment, wherein the programming device is capable of programming the patient-specific data into the memory device. In one exemplary embodiment, each drawer receptacle carries a corresponding programming device.

In another exemplary embodiment, the cart further includes a radio frequency identification (RFID) tag capable of providing location information relating to the cart to a central computer, wherein the central computer is capable of determining a location associated with the cart based at least in part on the location information. In yet another exemplary embodiment, the cart further includes a wireless computer platform operably connected to the reader, wherein the wireless computer platform is capable of receiving the patient-specific data from the reader. The wireless computer platform may further be capable of providing location information relating to the cart. In one exemplary embodiment, the wireless computer platform comprises a computer application capable of measuring at least one power level between one or more antennae associated with the wireless computer platform and one or more wireless access points, such that the at least one power level is capable of being used to determine the location information relating to the cart.

According to another exemplary embodiment, the wireless computer platform is capable of communicating the patient-specific data and the location information to a wireless computer network associated with a hospital in which the cart is located, such that the patient-specific data and the location information are capable of being used to generate a medication delivery and removal route.

In one exemplary embodiment, the drawers of the cart are capable of being locked in a closed position within the drawer receptacles by means of an electronic locking mechanism. The wireless computer platform of one exemplary embodiment is operably connected to the electronic locking mechanism and a computer application operating on the wireless computer platform is capable of activating the electronic locking mechanism.

In yet another exemplary embodiment, the wireless, mobile point-of-care cart further includes a messaging system such that the cart is capable of communicating with at least one of another wireless, mobile point-of-care cart or an information systems device associated with a pharmacy.

According to another aspect of the present invention, a mobile point-of-care system is provided. In one exemplary embodiment, the system includes: (1) one or more wireless, mobile point-of-care carts; (2) one or more patient-specific drawers capable of being carried by the cart, wherein each patient-specific drawer comprises a memory device capable of being read while onboard the cart to identify a patient associated with the patient-specific drawer; and (3) a tracking system for identifying the location of each of the carts, such that the location of each of the patient-specific drawers is capable of being identified.

According to another aspect of the present invention, a method of routing a medication delivery person throughout a hospital for delivering and removing medications from one or more mobile point-of-care carts is provided. In one exemplary embodiment the method includes: (1) receiving registration data corresponding with respective mobile point-of-care carts, the registration data indicating one or more patient-specific drawers registered to respective mobile point-of-care carts; (2) receiving tracking data corresponding with respective mobile point-of-care carts, the tracking data capable of being used to determine a location associated with respective mobile point-of-care carts; (3) determining, based on the registration and tracking data, a location associated with each patient-specific drawer; and (4) generating a medication delivery route based at least in part on said location associated with each patient-specific drawer.

In one exemplary embodiment, the tracking data comprises location information received from one or more radio frequency identification (RFID) tags associated with respective mobile point-of-care carts. In another exemplary embodiment, the tracking data comprises at least one power level between one or more antennae associated with respective mobile point-of-care carts and one or more access points located throughout the hospital. In this embodiment, the method further includes determining a location associated with respective mobile point-of-care carts based at least in part on the at least one power level. The method of another exemplary embodiment further includes maintaining a record of each patient-specific drawer registered to respective mobile point-of-care carts.

According to yet another aspect of the present invention, a computer program product for routing a medication delivery person throughout a hospital for delivering and removing medications from one or more mobile point-of-care carts is provided. The computer program product comprises at least one computer-readable storage medium having computer-readable program code portions stored therein. In one exemplary embodiment, the computer-readable program code portions include: (1) a first executable portion for receiving registration data corresponding with respective mobile point-of-care carts, the registration data indicating one or more patient-specific drawers registered to respective mobile point-of-care carts; (2) a second executable portion for receiving tracking data corresponding with respective mobile point-of-care carts, the tracking data capable of being used to determine a location associated with respective mobile point-of-care carts; (3) a third executable portion for determining, based on the registration and tracking data, a location associated with each patient-specific drawer; and (4) a fourth executable portion for generating a medication delivery route based at least in part on said location associated with each patient-specific drawer.

### BRIEF DESCRIPTION OF THE SEVERAL VIEWS OF THE DRAWING(S)

For the present invention to be easily understood and readily practiced, the present invention will now be described, for purposes of illustration and not limitation, in conjunction with the following figures, which are not necessarily drawn to scale, and wherein:

FIG. 1 illustrates a wireless, mobile point-of-care cart constructed according to exemplary embodiments of the present invention;

FIG. 2 illustrates another exemplary embodiment of a wireless, mobile, point-of-care cart constructed according to the teachings of exemplary embodiments of the present invention with additional details of the drawers illustrated;

FIG. 3 illustrates a system in which cart location can be determined in accordance with exemplary embodiments of the present invention;

FIG. 4 illustrates a dispensing methodology using the cart of either FIG. 1 or FIG. 2 in accordance with exemplary embodiments of the present invention;

FIG. 5 is a flow chart illustrating that portion of the process of FIG. 4 from filling pharmacy orders to delivery of those orders and/or removal of discontinued medications from mobile point-of-care carts in accordance with exemplary embodiments of the present invention;

FIG. 6 is an example of a medication delivery/removal report in accordance with exemplary embodiments of the present invention; and

FIG. 7 is a flow chart illustrating an exemplary process for registering (correlating) patient data to medication containers in accordance with exemplary embodiments of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

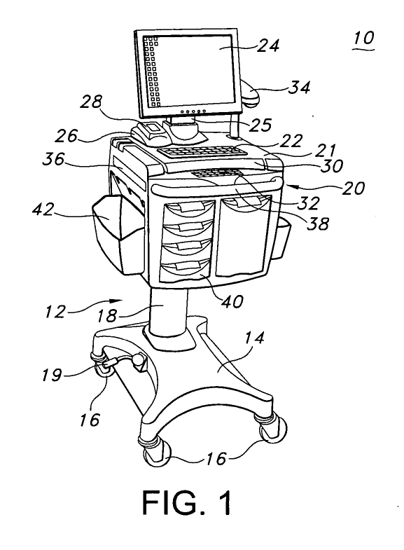

Reference is now made to FIG. 1, which illustrates a wireless, mobile, point-of-care system or cart 10 constructed according to exemplary embodiments of the present invention. The cart 10 provides an all-in-one tool for healthcare workers. Both medications and supplies travel with the healthcare worker such that medications, supplies and documentation are maintained in one place. According to one exemplary embodiment, the cart 10 is comprised of a frame 12 having a base 14 carrying swivel casters 16, some or all of which may be lockable, and an adjustable column 18. A power supply, not shown, may be carried in the base. A recharging cord 19 may further be provided so that the power may be recharged.

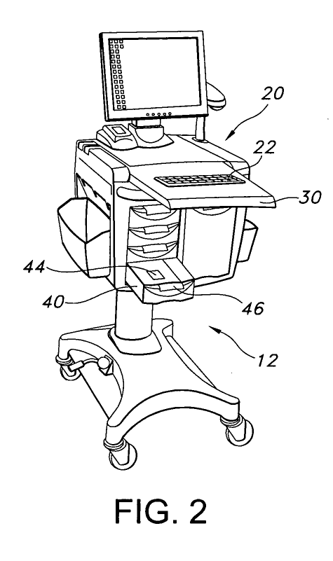

The adjustable column 18 of exemplary embodiments may carry a housing 20, which defines an upper work surface 21. The housing 20 may carry on its upper work surface 21 a keyboard 22, a screen 24 (optionally touch sensitive) held in place by a mounting arm 25, and a docking station 26 for a handheld administration device 28 (e.g., an Horizon Admin-Rx handheld device available from McKesson Automation Inc.). Alternatively, or in addition, a retractable keyboard tray 30 may be provided for keyboard 22 (see FIG. 2). An onboard computer (not shown) may be housed in the bottom of the housing 20. The onboard computer may be responsive to a keypad 32. A barcode reader 34, a side work surface tray 36 and a handle 38 may also be provided. Those of ordinary skill in the art will recognize that a mobile cart may be constructed using other types of frames 12 and housings 20 having other features without departing from the spirit and scope of exemplary embodiments of the present invention.

In one exemplary embodiment, two medication container options are provided: drawers 40 carried within an internal storage area defined within housing 20, or alternatively, bins carried within an internal storage area defined within the housing 20 for envelopes. The interior of the side walls of the housing 20 may be provided with appropriate hardware, not shown, to allow the drawers 40 (which may be patient-specific bins) to slide in and out of the housing 20 and to allow the drawers to be locked when in a closed position.

In one exemplary embodiment, when inserted into the cart, these drawers 40 may be locked in a closed position by means of an electronic locking mechanism. The electronic locking mechanism may be activated to unlock by means of a multi-digit code entered through the numeric keypad 32 housed on the body of the cart. Other means of inputting the code, such as reading a bar code or a radio frequency identification (RFID) tag on a user badge may similarly be used. The cart of exemplary embodiments may further be equipped with a wireless computing platform, which may be operably connected to the above-mentioned drawer locking mechanism. Through a special software service, a computer application operating on the wireless computer may be enabled to activate the locking and unlocking mechanism of the cart. By allowing the software application operating on the computer platform to directly control the patient container locking mechanism, exemplary embodiments of the present invention eliminate unnecessary data entry.

The drawers 40, one of which is shown in an open position in FIG. 2, may further be provided with a read/write RF drawer tag 44 (or other programmable read/write memory device or circuit) and a label 46 that may have both human readable and bar code indicia. The programmable read/write memory device may be used in conjunction with other components to create an auto-identification system to automatically identify the patient-specific drawers within a particular cart, which is discussed in detail below. In addition, each cart itself may be equipped with an RFID tag (not shown) in order to provide location information relevant to the cart (also discussed below). Both the drawers 40 and envelopes may be filled by centralized automation. The cart 10 of exemplary embodiments of the present invention can be integrated into a hospital's medication delivery, administration and documentation process as will be described in greater detail below.

As stated above, with the introduction of mobile medication management systems a need has arisen for pharmacy and nursing staff to be able to quickly and easily locate patient medication containers where these containers are no longer being maintained in specific areas. According to exemplary embodiments of the present invention, the wireless, mobile point-of-care system or cart 10 provides for the auto-identification of medication containers or drawers through the incorporation of a read/write system. In one exemplary embodiment, the read/write system is comprised of three major components. The first component is the RFID tag 44 or other memory device or circuit that is carried on each patient-specific medication drawer or bin 40 that may be inserted into the cart 10. The second component is a programming device (not shown), which may write patient-specific data to the tag 44 or other memory device or circuit. A reader (not shown), such as a contact or proximity-based reader, which may, in one exemplary embodiment, be installed in each of the patient medication drawer receptacles on the cart makes up the third component and is capable of reading and/or decoding the data from the tag or other memory device or circuit 44.

To illustrate, in one exemplary embodiment, each patient medication drawer 40 carried by the cart 10 may be identified with a unique patient identifier which is associated with and uniquely identifies a respective patient. The association between the unique patient identifier and the respective patient may be maintained by the onboard computer and/or by a remote computer system, such as a central server. The programmable read/write tag or other memory device or circuit 44 carried by each patient medication drawer 40 stores that unique patient data. The unique identifying data permits the onboard computer operating in conjunction with the plurality of readers within cart 10 to identify each patient medication drawer 40 as belonging to a particular patient when that drawer is inserted into one of the receptacles on the cart 10 and the programmable read/write tag or other memory device or circuit 44 is read by a reader as discussed below. Although the programmable read/write tag or other memory device or circuit 44 is described to store the unique patient identifier, the programmable read/write tag or other memory device or circuit 44 can also store other associated information, such as the medication dispensed to the respective patient. In one exemplary embodiment, the cart 10 can also identify when a patient medication drawer has been removed, since the reader will no longer detect the presence of the programmable read/write tag or other memory device or circuit 44 associated with the respective drawer.

When patient medication drawers 40 are to be filled with medication (either by the nursing or pharmacy department), the programming device (not shown) may be employed to transmit a unique patient identifier to the read/write tag or other memory device or circuit 44. This unique patient identifier is also stored by the onboard computer and/or by a remote computer system, such as a central server. A programming device may be installed in each of the cart's drawer receptacles permitting a drawer 40 to be programmed with patient data after it has been inserted into the cart, or the programming device may be an independent device utilized in the filling process by pharmacy or nursing staff.

In one embodiment, each receptacle on the cart may have the capability to read and/or decode data from a previously programmed read/write tag or other memory device or circuit 44. For this purpose, a reading device or reader may be employed in each drawer receptacle. Additionally, or alternatively, one or more independent reading devices (i.e., not directly corresponding with each drawer receptacle) may be employed to read the data that has been programmed to a patient medication drawer 40. For example, a cart 10 may include one or a fewer number of reading devices than drawers with the reader(s) communicating with the programmable read/write tag or other memory device or circuit 44 associated with multiple drawers. Based on the foregoing, when patient-specific drawers are inserted into a cart, the cart of exemplary embodiments would be automatically “aware” of the patients for which it carries medications and supplies.

In addition to being able to automatically identify specific patient medication containers or drawers within a particular cart, exemplary embodiments of the present invention further provide for locating, in real time, each cart within the hospital, nursing home or other similar facility. In particular, in one exemplary embodiment, the cart may be further equipped with a tracking system, such as a radio-frequency-based tracking system, which may operate by means of a wireless computer contained in the cart in connection with the hospital's wireless network, or an active RFID tag connected to the cart itself, in order to provide real-time location information relating to the cart. The combination of these features (i.e., auto-identification of medication containers and real-time cart locating) provides pharmacy and nursing staff with real-time location information of each patient medication container. In other words, with this combination of technology, pharmacy and nursing staff would be capable of always knowing to which cart a patient drawer has been associated and where that cart is located in the hospital at any given time. This may be particularly useful, for example, when delivering medications for each patient to the various mobile medication carts. As is discussed in more detail below, this location information may be used to generate a medication delivery/removal plan or route that can be used by pharmacy or other delivery personnel in order to greatly reduce the burden of delivering medications throughout the hospital.

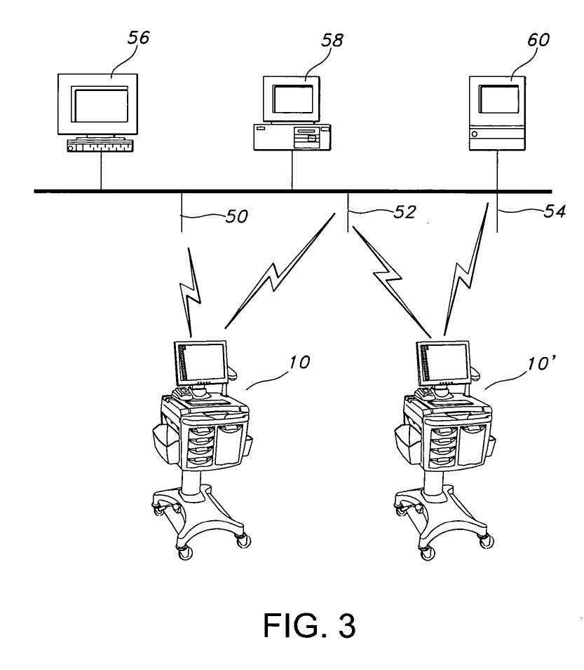

Turning to FIG. 3, which illustrates one exemplary means of providing real-time location information for various carts, a radio frequency locating system may utilize commercially available technology available from, for example, Ekahau (www.ekahau.com), or PanGo Networks (as described in U.S. Pat. No. 6,347,095) to provide the location of any cart, in real time. The radio-frequency locating system of this exemplary embodiment is comprised of the following primary components. PC-based software running on the cart's wireless computer may be capable of measuring the power levels between the cart's computer's antennae (not shown) and the various wireless network access points 50, 52, 54 to which the cart's wireless computer has access. The power level for each access point to which the cart is in contact will rise and fall as the cart approaches an access point and then moves away from that point, respectively. A server 56 may be further provided to run software capable of interpreting the power level data measured by the PC-based software so as to provide a discrete location for each cart 10, 10′ based on the power level data for that cart. The location information may not only be provided to the cart 10, but may also be provided to any other cart 10′, desktop computer 58 or handheld computing device 60.

As carts 10, 10′ are traveling throughout the healthcare facility, the wireless computer installed in each cart may be in communication with the hospital's wireless computer network for the purpose of transmitting data back and forth between the cart and the hospital's clinical information systems as is known in the art. The wireless computer infrastructure used for the transmission of that data can also be used for the wireless tracking system of embodiments of the present invention.

As will be recognized by those of ordinary skill in the art, the foregoing is but one means for generating real-time location information for the wireless, mobile point-of-care systems or carts. Other such means may be similarly used without departing from the spirit and scope of the present invention.

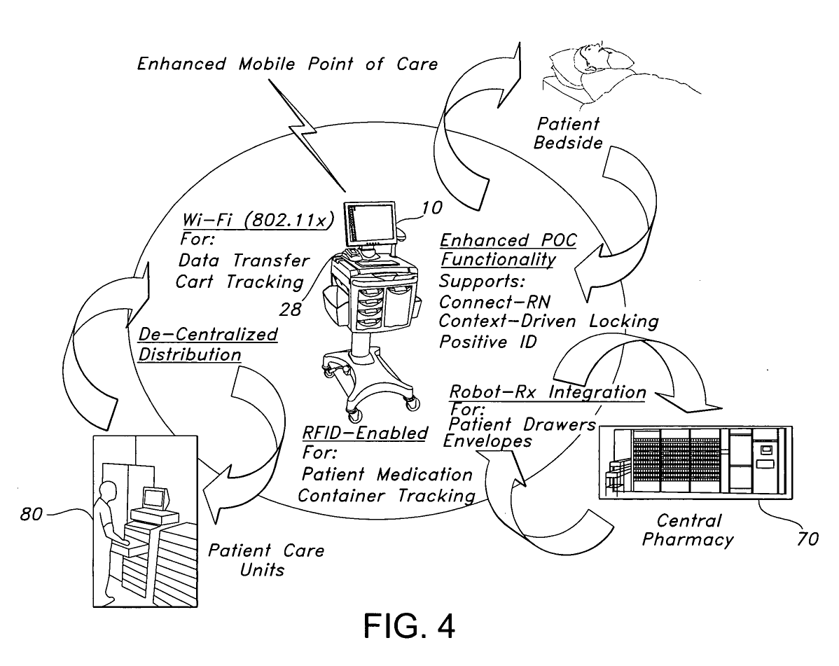

Bedside scanning of medications concurrent with administration of the medications to a patient can change the way healthcare facilities think about dispensing automation. With bedside scanning, clinicians now have mobile clinical information and a quality check at the “back end” of the process. This helps clinicians ensure medication safety while also improving efficiencies by simultaneously documenting the administration process. With that in mind, a methodology for dispensing medications will now be described with reference to FIGS. 4-7.

The components illustrated in FIG. 4 include a centralized medication dispensing system 70 (e.g., Robot-Rx medical robot, MedCarousel medical carousel, etc.) implementing several delivery options, such as patient-specific drawers (cassettes or bins) for use with mobile point-of-care systems 10 and/or patient-specific envelopes which can be delivered to a nurse server in the patient's room or carried by a point-of-care system in its bins 42. A decentralized distribution center 80, which may be located within a patient care unit, may be comprised of AcuDose-Rx® two drawer main cabinets with high-capacity drawers for controlled substance storage. Also illustrated in FIG. 4 is a wireless, mobile, point-of-care system 10 having patient-specific medication drawers 40 filled, for example, by the Robot-Rx medical robot and delivered to the nursing units. Pharmacy personnel may perform a cart exchange similar to accepted practice. Additionally, the wireless, mobile point-of-care system 10 may have a wireless PC capable of running medication administration and clinical documentation applications.

The dispensing methodology illustrated in FIG. 4 takes advantage of the capabilities of the cart 10 to provide healthcare workers with the ability to manage medications, supplies and clinical documentation activities with one tool. In the illustrated model, healthcare workers are able to provide care to between one and ten patients with a single cart 10.

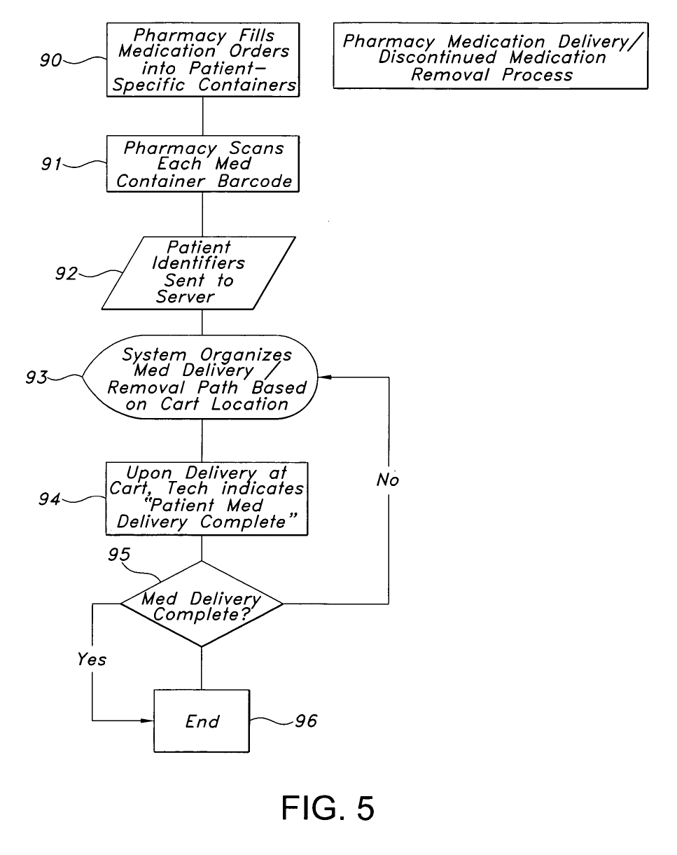

Referring now to FIG. 5, the portion of the medication dispensing process between filling pharmacy orders and delivering those orders to mobile point-of-care carts on the nursing units is illustrated in accordance with one exemplary embodiment of the present invention. In the central pharmacy department, patient medication drawers 40 are filled at step 90 using, for example, the centralized automation system technology. The filled drawers may be provided with a bar code containing the unique patient identifier that is scanned at 91 with the patient identifiers being sent to the server at 92 and associated with the medications dispensed to the patient. The drawers 40 can then be inserted in drawer cassettes and delivered by pharmacy personnel to the nursing units.

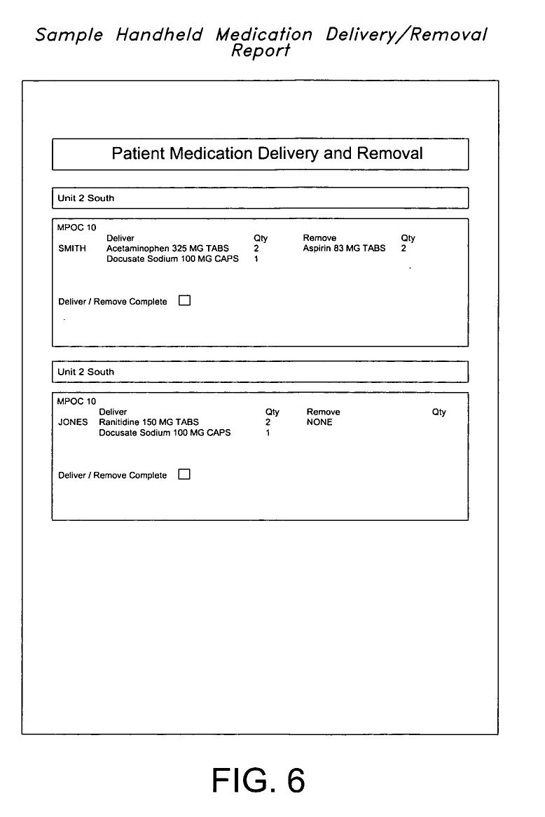

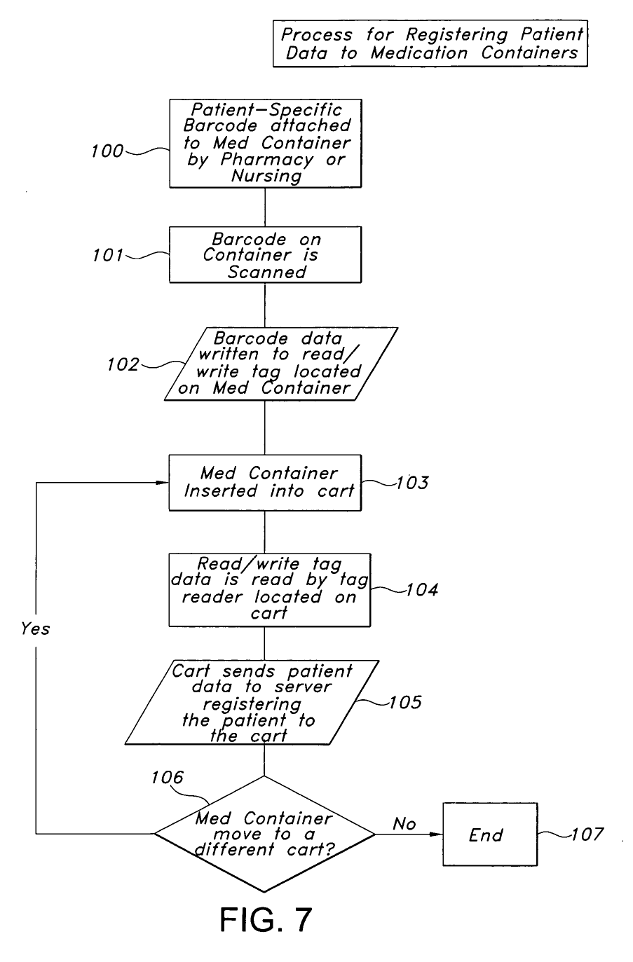

In one exemplary embodiment, the system (e.g., server 56) maintains a record of each patient medication container that has been registered to a cart. (See below for discussion of correlating patient specific data to the medication containers with reference to FIG. 7.) Using the data that the registration process creates along with the real-time location information for each cart, the system at 93 organizes a medication delivery/removal plan and may provide medication delivery/removal reports of the type illustrated in FIG. 6. For example, in one exemplary embodiment, the medication delivery/removal plan provides pharmacy personnel with an ordered list of patients for which to deliver or remove medications based on the specific location of each patient's drawer within the hospital.

For example, assume that it is determined, based on the auto-identification and real-time tracking systems discussed above, that the patients' medication drawers are located according to Table 1 below.

TABLE 1
Exemplary Patient/Cart Locations

| Floor | Wing/Unit | Cart | Patient |
|---|---|---|---|
| 1 | East | A | Joe |
| | | | Kevin |
| | West | B | Laura |
| | | | Madison |
| 2 | East | C | Nathan |
| | | | Otis |
| 3 | West | D | Paul |
| | | | Rachel |
| | South | E | Steve |
| | | | Vince |
| | North | F | Wes |
| | | | Yvanna |

Assume further that the hospital elevators are located on the north wall of the hospital and that either the entrance to the hospital or the pharmacy (i.e., the direction from which the pharmacy personnel would be coming from) is on the west wall. Based on the foregoing, the server of exemplary embodiments of the present invention may generate the medication delivery/removal plan or route shown below in Table 2.

TABLE 2
Exemplary Medication Delivery/Removal Plan

| | | | | | Medications to Deliver/Remove | | | |
|---|---|---|---|---|---|---|---|---|
| | Patient | Floor | Cart | Location | Deliver | Qty | Remove | Qty |
| 1 | Laura | 1 | B | West | Aspirin 325 MG Tab | 2 | NONE | |
| 2 | Madison | 1 | B | West | Ranitidine 150 MG Tab | 1 | NONE | |
| 3 | Joe | 1 | A | East | NONE | | Acetaminophen 325 MG Tab | 2 |
| 4 | Kevin | 1 | A | East | Docusate Sodium 100 MG Capsule | 1 | NONE | |
| 5 | Nathan | 2 | C | East | Aspirin 325 MG Tab | 1 | NONE | |
| 6 | Otis | 2 | C | East | NONE | | Ranitidine 150 MG Tab | 1 |
| 7 | West | 3 | F | North | Acetaminophen 325 MG Tab | 2 | NONE | |
| 8 | Yvanna | 3 | F | North | Coumadin 5 MG Tab | 1 | Aspirin 325 MG Tab | 2 |
| | | | | | Ibuprofen 200 MG Tab | 3 | | |
| 9 | Paul | 3 | D | West | Niacin 1000 MG Tab | 1 | Furosemide 80 MG Tab | 1 |
| 10 | Rachel | 3 | D | West | NONE | | Niacin 1000 MG Tab | 1 |
| 11 | Steve | 3 | E | South | Famciclovir 250 MG Tab | 1 | NONE | |
| 12 | Vince | 3 | E | South | NONE | | Ranitidine 150 MG Tab | 1 |

As will be understood by those of ordinary skill in the art, this is but one example of a medication delivery/removal plan or route that could be generated in accordance with exemplary embodiments of the present invention. For example, rather than indicating cart locations by means of the wing of the hospital in which it is located (i.e., East, West, North or South), a cart's location may be indicated by the room number of the room to which it is closest or any other means for indicating the cart's location.

In general, as described above, in one exemplary embodiment, a server receives data indicating which patient-specific drawers are registered with respective mobile point-of-care carts throughout the hospital (as discussed in detail with reference to FIG. 7 below), as well as data that can be used to determine the location of each mobile point-of-care cart. The server uses this data to generate a medication delivery/removal plan or route.

Returning now to FIG. 5, once the pharmacy personnel or technician reaches the cart (using the generated medication delivery/removal plan or route or otherwise), medications are delivered to and/or removed from the mobile point-of-care carts at 94. When all of the patient medication deliveries/removals have been completed, as shown by the inquiry 95, that portion of the process is completed. At this point, the pharmacy personnel or technician may indicate that the delivery and/or removal has been completed, such as via the entry of appropriate data in a mobile computing device, such as a handheld personal data assistant (PDA) carried by the pharmacy personnel or technician. The screen display for patients Smith and Jones is shown in FIG. 6, along with the checkbox that receives input from the pharmacy personnel or technician upon completion of the delivery/removal.

Reference is now made to FIG. 7, which provides an example of the registration process (i.e., the process by which patient data is correlated with a patient drawer, a/ka/ a medication container) in accordance with exemplary embodiments of the present invention. In one exemplary embodiment, the process begins at 100 where a patient-specific barcode is attached to a medication container by a pharmacy or healthcare worker. At 101 the barcode on the container is scanned. At 102, the scanned data that uniquely identifies the patient is written to a tag or other memory device or circuit 44 carried on the patient-specific container or drawer using, for example, the programming device discussed above. The medication container may then be inserted into a cart at 103. At 104, the tag or other memory device or circuit 44 is read by a reader located on cart 10, for example a reader installed in the medication drawer receptacle of the cart, to obtain the identification of the patient associated with the medication container. The cart 10 and, more typically, the onboard computer is then able to send the patient data to a server (e.g., server 56) thus registering the patient to that cart. An inquiry 106 may be periodically performed to determine if the medication container has been moved to a different cart. If not, the process ends at 107. If the container has been moved, the process returns to 103.

The unique patient identifier that is stored by the programmable read/write tag or other memory device or circuit 44 can also be utilized during administration of the medications to a patient. In this regard, the nurse can open a drawer with the onboard computer automatically identifying the associated patient, such as by means of reading the unique patient identifier stored by the tag associated with the drawer. The nurse can then enter the medications to be administered, such as by means of the keyboard 22, a touch screen 24 or the like. The nurse can then positively identify the patient, such as by scanning the barcode or other tag carried by a wristband worn by the patient. The onboard computer and/or a remote computer system, such as a central server, can then confirm that the patient associated with the drawer is identical to the positively identified patient. If there is a mismatch, the computer will alert the nurse prior to administration of the medications. Otherwise, the nurse will proceed to administer the medications and will then notify the onboard computers, such as by means of the keyboard 22, the touch screen 24 or the like, that the medications have been administered to the respective patient, such that the computer system can automatically update the patient's chart or other medical records and can similarly decrement the inventory of medications maintained by the patient drawer.

The cart 10 may be used alone or in conjunction with a wireless, handheld administrative device 28. Both the cart 10 (e.g., the onboard computer) and the device 28 may host, for example, any of McKesson's nursing applications including Horizon Admin-Rx, Connect-RN, Horizon Expert Documentation and Mobile Care Transfusion and Phlebotomy. Using exemplary embodiments of the present invention, at the bedside, healthcare workers prepare medications for administration, verify administration activities, provide medical-surgical supplies if necessary, and document bedside activities.

Based on the foregoing, through the use of RFID technology, determining the location of patient drawers anywhere in the hospital is reduced to a simple mouse-click at any system PC. As described above, patient drawers may be tagged with an RFID tag 44 and subsequently registered to a wireless cart. The RF-enabled cart may be tracked in the hospital utilizing commercially available technology. With that combination of technology, pharmacy and nursing would always know to which cart a patient drawer has been associated, and where a cart is located in the hospital at any given time.

Through the use of an instant messaging application and voice-over-IP communications, carts of other exemplary embodiments of the present invention further provide users with the ability to communicate with one another and/or to communicate with the pharmacy department or other hospital departments (e.g., information systems devices associated with those departments) right from the user's primary tool. Through the use of the on-board messaging system, pharmacy and nursing staff can quickly locate another staff member with whom they desire to communicate, and then efficiently communicate while working directly with the mobile point-of-care system. This system could also provide customized messages to be displayed to healthcare workers. Such messages might include, for example, key reminders, information about policy changes, medication shortages, etc.

When controlled substance access is required, healthcare workers may retrieve these medications from the AcuDose-Rx® two drawer main cabinet outfitted with high-capacity drawers. This cabinet has been optimized to provide controlled substance storage for up to eighty individual medication line items while requiring a fraction of the space typically required by a standard unit-based cabinet.

The cart 10 of exemplary embodiments of the present invention provides a mobile, bedside, point-of-care solution. The cart 10 of exemplary embodiments provides a great deal of flexibility for the healthcare worker and fits into existing pharmacy distribution models without impacting current labor. In addition, the cart 10 may be used to support both a centralized and a decentralized dispensing methodology.

While the present invention has been described in connection with preferred embodiments thereof, those of ordinary skill in the art will recognize that many modifications and variations are possible. For example, it is anticipated that carts containing less than all of, as well as various combinations of, the aforementioned features may be constructed without departing from the teachings of the present disclosure. The present invention is intended to be limited only by the following claims and not by the forgoing description which is intended to set forth the presently preferred embodiment.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A wireless, mobile point-of-care cart comprising:
a mobile frame including a housing defining a plurality of drawer receptacles, said housing carrying at least one reader; and
a plurality of drawers each sized to fit within one of said drawer receptacles, each of said drawers carrying a memory device capable of retaining patient-specific data, wherein said patient-specific data is capable of being read from said memory device by said at least one reader.

2. The cart of claim 1, wherein each drawer receptacle carries a corresponding reader.

3. The cart of claim 1, wherein said memory device comprises a radio frequency identification (RFID) tag, and wherein said at least one reader is an RFID reader.

4. The cart of claim 1 wherein said housing further carries at least one programming device capable of programming said patient-specific data into said memory device.

5. The cart of claim 4, wherein each drawer receptacle carries a corresponding programming device.

6. The cart of claim 1 further comprising:
a radio frequency identification (RFID) tag capable of providing location information relating to said cart to a central computer, said computer capable of determining a location of said cart based at least in part on said location information.

7. The cart of claim 1 further comprising:
a wireless computer platform operably connected to said at least one reader, said wireless computer platform capable of receiving said patient-specific data from said at least one reader.

8. The cart of claim 7, wherein said wireless computer platform is capable of providing location information relating to said cart.

9. The cart of claim 8, wherein said wireless computer platform comprises a computer application capable of measuring at least one power level between one or more antennae associated with said wireless computer platform and one or more wireless network access points, such that said at least one power level is capable of being used to determine said location information relating to said cart.

10. The cart of claim 8, wherein said wireless computer platform is capable of communicating said patient-specific data and said location information to a wireless computer network associated with a hospital in which said cart is located such that said patient-specific data and said location information are capable of being used to generate a medication delivery and removal route.

11. The cart of claim 7, wherein said drawers are capable of being locked in a closed position within said drawer receptacles by means of an electronic locking mechanism.

12. The cart of claim 11, wherein said wireless computing platform is operably connected to said electronic locking mechanism, and wherein a computer application operating on said wireless computer platform is capable of activating said electronic locking mechanism.

13. The cart of claim 1, wherein said cart further comprises a messaging system such that said cart is capable of communicating with at least one of another wireless, mobile point-of-care cart or an information systems device associated with a pharmacy.

14. A mobile point-of-care system comprising:
one or more wireless, mobile point-of-care carts;
one or more patient-specific drawers capable of being carried by said carts, wherein each patient-specific drawer comprises a memory device capable of being read while onboard said cart to identify a patient associated with said patient-specific drawer; and
a tracking system for identifying the location of each of said carts such that the location of each of said patient-specific drawers is capable of being identified.

15. The system of claim 14, wherein said memory device is capable of retaining patient-specific data, and wherein said cart comprises at least one reader capable of reading said patient-specific data from said memory device.

16. The system of claim 15, wherein each of said carts comprises a mobile frame including a housing defining a plurality of drawer receptacles configured to hold said patient-specific drawers.

17. The system of claim 16, wherein each drawer receptacle carries a corresponding reader.

18. The system of claim 16 further comprising:
at least one programming device configured to write said patient-specific data to said memory device.

19. The system of claim 18, wherein each drawer receptacle carriers a corresponding programming device.

20. The system of claim 15, wherein said memory device comprises a radio frequency identification (RFID) tag, and wherein said at least one reader comprises an RFID reader.

21. The system of claim 14, wherein said tracking system comprises:
one or more radio frequency identification (RFID) tags associated with respective mobile point-of-care carts, said RFID tags capable of providing location information relating to said carts; and
a central computer capable of receiving said location information and of determining a location associated with said cart based at least in part on said location information.

22. The system of claim 15, wherein said cart further comprises a wireless computer platform operably connected to said at least one reader such that said wireless computer platform is capable of receiving said patient-specific data from said at least one reader.

23. The system of claim 22, wherein said tracking system comprises:
one or more wireless access points to which said wireless computer platform has access;
a computer application operating on said wireless computer platform, said application capable of measuring at least one power level between one or more antennae associated with said wireless computer platform and said access points; and
a server operably connected to said wireless computer platform, wherein said server is configured to receive said at least one power level and to generate location information associated with said cart based at least in part on said at least one power level.

24. The system of claim 23, wherein said server is further configured to receive said patient-specific data from said wireless computer platform, and wherein said server is capable of generating a medication delivery and removal route based at least in part on said location information associated with said cart and said patient-specific data.

25. The system of claim 22, wherein said patient-specific drawers are capable of being locked in a closed position within said cart by means of an electronic locking mechanism.

26. The system of claim 24, wherein said wireless computing platform is operably connected to said electronic locking mechanism, and wherein a computer application operating on said wireless computer platform is capable of activating said electronic locking mechanism.

27. The system of claim 14, wherein said cart comprises a messaging system such that said cart is capable of communicating with at least one of another wireless, mobile point-of-care cart or an information systems device associated with a pharmacy.

28. A method of routing a medication delivery person throughout a hospital for delivering and removing medications from one or more mobile point-of-care carts, said method comprising:
receiving registration data corresponding with respective mobile point-of-care carts, said registration data indicating one or more patient-specific drawers registered to respective mobile point-of-care carts;
receiving tracking data corresponding with respective mobile point-of-care carts, said tracking data capable of being used to determine a location associated with respective mobile point-of-care carts;
determining, based on said registration data and said tracking data, a location associated with each patient-specific drawer; and
generating a medication delivery route based at least in part on said location associated with each patient-specific drawer.

29. The method of claim 28, wherein said registration data and said tracking data are received from respective mobile point-of-care carts.

30. The method of claim 29, wherein said registration data is generated by respective mobile point-of-care carts based on patient-specific data read from one or more memory devices carried by corresponding patient-specific drawers registered to said mobile point-of-care carts.

31. The method of claim 29, wherein said tracking data comprises location information received from one or more radio frequency identification (RFID) tags associated with respective mobile point-of-care carts.

32. The method of claim 29, wherein said tracking data comprises at least one power level between one or more antennae associated with respective mobile point-of-care carts and one or more access points located throughout said hospital, and wherein said method further comprises:
determining a location associated with respective mobile point-of-care carts based at least in part on said at least one power level.

33. The method of claim 28 further comprising:
maintaining a record of each patient-specific drawer registered to respective mobile point-of-care carts.

34. A computer program product for routing a medication delivery person throughout a hospital for delivering and removing medications from one or more mobile point-of-care carts, wherein the computer program product comprises at least one computer-readable storage medium having computer-readable program code portions stored therein, the computer-readable program portions comprising:
a first executable portion for receiving registration data corresponding with respective mobile point-of-care carts, said registration data indicating one or more patient-specific drawers registered to respective mobile point-of-care carts;
a second executable portion for receiving tracking data corresponding with respective mobile point-of-care carts, said tracking data capable of being used to determine a location associated with respective mobile point-of-care carts;
a third executable portion for determining, based on said registration data and said tracking data, a location associated with each patient-specific drawer; and
a fourth executable portion for generating a medication delivery route based at least in part on said location associated with each patient-specific drawer.

35. The computer program product of claim 34, wherein said registration data and said tracking data are received from respective mobile point-of-care carts.

36. The computer program product of claim 35, wherein said registration data is generated by respective mobile point-of-care carts based on patient-specific data read from one or more memory devices carried by corresponding patient-specific drawers registered to said mobile point-of-care carts.

37. The computer program product of claim 35, wherein said tracking data comprises location information received from one or more radio frequency identification (RFID) tags associated with respective mobile point-of-care carts.

38. The computer program product of claim 35, wherein said tracking data comprises at least one power level between one or more antennae associated with respective mobile point-of-care carts and one or more access points located throughout said hospital, and wherein said computer-readable program portions further comprise:
determining a location associated with respective mobile point-of-care carts based at least in part on said at least one power level.

39. The computer program product of claim 34 further comprising:
a fifth executable portion for maintaining a record of each patient-specific drawer registered to respective mobile point-of-care carts.
